(19) United States
(12) Patent Application Publication
(10) Pub. No.: US 2014/0336900 A1
(43) Pub. Date: Nov. 13, 2014

(54) METHOD FOR OPERATING AN INTERNAL COMBUSTION ENGINE

(71) Applicant: ROBERT BOSCH GMBH, Stuttgart (DE)

(72) Inventors: Carsten Deringer, Aichwald (DE); Robert Schmidt, Karlsruhe (DE)

(21) Appl. No.: 14/349,308

(22) PCT Filed: Sep. 20, 2012
(86) PCT No.: PCT/EP2012/068556

§ 371 Date: Apr. 2, 2014

(30) Foreign Application Priority Data
Oct. 6, 2011 (DE) 10 2011 084 081.8

(51) Int. Cl. F02D 29/02

(52) U.S. Cl. CPC F02D 29/02
USPC 701/101

(57) ABSTRACT

A method for operating an internal combustion engine, in which a most probable position angle is ascertained. The most probable position angle generally corresponds to a rotational position of the internal combustion engine. Position angles are each assigned at least two probabilities. The at least two probabilities are linked with each other. The most probable position angle out of the position angles is ascertained as a function of the linked probabilities.

### FIELD

The present invention relates to a method for operating an internal combustion engine.

### BACKGROUND INFORMATION

Typically an encoder gear wheel, which is situated on a crankshaft and a camshaft, is evaluated to ascertain the position, in particular a position angle, of the internal combustion engine. Other functions for determining the position angle are also available.

In addition, conventional methods evaluate the reliability of the ascertainment of the position angle. For example, a method for determining a detection error for a detected rotational angle of a shaft is described in German Patent Application No. DE 10 2009 000 716 A1.

### SUMMARY

Features which may be important for the present invention may also be found in the description below and in the figures; the features may be important for the present invention either alone or also in various combinations, without making explicit reference thereto again.

By assigning at least two probabilities to each position angle, it is advantageously possible that a function for position determination, which may not clearly select a certain position angle, for example, may ascertain and output at least a probability distribution with respect to the position angles. The function may thus be included in the ascertainment of a most probable position angle in a simple manner. A number of functions may subsequently be used to determine the most probable position angle. For this purpose, the probabilities of all existing functions which are assigned to the position angle are linked for each position angle. The angle probability distribution thus constitutes a uniform interface, the use of which allows functions which use a wide variety of physical methods to be linked with each other.

In one advantageous refinement of the example method, the assigned probabilities of at least two different functions are ascertained for each position angle, and different weighting factors are assigned to the functions. The most probable position angle out of the position angles is then ascertained as a function of the probabilities and as a function of the weighting factors. In this way, for example, a different sensor behavior may advantageously be taken into consideration. For example, the reliability or imprecision of sensors may be represented, and thus taken into consideration, by weighting factors and the form of the probability distribution.

In one advantageous refinement of the method, a quality is ascertained for each position angle as a function of the probabilities and the weighting factors. The most probable position angle out of the position angles may advantageously be determined as a function of the quality, and in this way a variable is ascertained which allows a comparison between the position angles based on a shared quality probability distribution.

In one advantageous refinement of the method, a maximal quality is ascertained from the ascertained qualities, the most probable position angle being the position angle to which the maximal quality is assigned.

Additional features, application options and advantages of the present invention are derived from the following description of exemplary embodiments of the present invention, which are shown in the figures of the drawings. All described or illustrated features, either alone or in any arbitrary combination, form the subject matter of the present invention, regardless of the wording or representation thereof in the description or in the figures. Functionally equivalent variables in all figures are denoted by identical reference symbols, even in different specific embodiments.

### BRIEF DESCRIPTION OF THE DRAWINGS

Exemplary specific embodiments of the present invention are described hereafter with reference to the figures.

FIG. 1 shows a schematic block diagram for ascertaining a most probable position angle.

FIG. 2 shows an exemplary diagram, in which probabilities and a quality are plotted against position angles.

### DETAILED DESCRIPTION OF EXAMPLE EMBODIMENTS

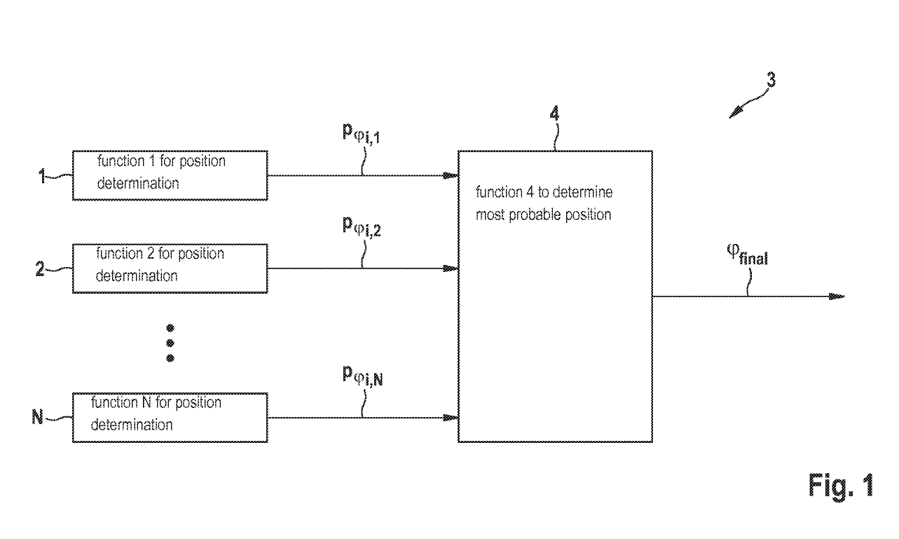

FIG. 1 shows a schematic block diagram 3 for ascertaining a most probable position angle φ_{final}. A function 1 for position determination generates a probability distribution p_{φi,1} for position angles φi. A function 2 for position determination generates a probability distribution p_{φi,2} for position angles φi. A function N for position determination generates a probability distribution φ_{i,N} for position angles φi. Probability distributions p_{φi,1} through p_{φi,N}, or p_{φi,n} in general, describe a probability of occurrence of position angles φi. In general, reference symbol p_{φi,n} also denotes a single probability or an individual value of a probability distribution. Probability distributions p_{φi,1} through p_{φi,N} are ascertained with the aid of functions 1 through N and are supplied in each case to a function 4 for determining the most probable position angle φ_{final}. For example, one of the functions 1 through N must only transmit the probabilities of probability distribution p_{φi,n} to function 4 for which the possibility of an occurrence of certain position angles φi or of one certain position angle φi was ascertained, function 4 correspondingly not expecting an occurrence for the other position angles φi for which no probability was transmitted.

Functions 1 through N are acted upon, in a form not shown, by variables from which the corresponding probability distributions p_{φi,n} are ascertained. For example, a crankshaft signal and a camshaft signal, which are ascertained with the aid of an appropriate sensor and an encoder gear wheel, are supplied to one of functions 1 through N to assign a particular probability p_{φi,n} in each case to one or multiple position angles φi.

Another embodiment of one of functions 1 through N includes the estimation and hence the assignment of individual probabilities p_{φi,n} to position angles φi by observing the course of a rotational speed of the internal combustion engine, the rotational speed being supplied to the corresponding function 1 through N. Position angles φi may also be assigned different probabilities p_{φi,n} based on a course of a cylinder internal pressure, a rail pressure or an intake manifold pressure. However, probabilities p_{φi,n} of position angles φi may also be inferred with the aid of test injections and the corresponding observation of the course of the rotational speed or the torque. Probabilities p_{φi,n} may also be ascertained from an observation of the voltage curve of a generator.

The above-mentioned options for ascertaining probability distribution p_{φi,n} for the particular position angles φi are carried out in each case by a function n of functions 1 through N, and each of these functions n is/is being assigned a weighting factor facₙ. According to equation 1, at least two probabilities p_{φi,n} are linked with assigned weighting factors facₙ for N>=2, weighting factors facₑ being assigned to the different functions 1 through N, and thus to probability distributions p_{φi,n}.

The particular weighting factor facₙ may either be selected to be a fixed value or may be determined during the operation as a function of operating variables, such as the rotational speed or the temperature of the internal combustion engine. Determining weighting factors facₙ as a function of one or multiple operating variables has the advantage that the different reliability of the particular function, which changes as a function of the particular operating state, may be taken into consideration.

According to equation 1, a quality Q_{φi} is ascertained for each position angle φi. The total number of position angles φi is limited, for which reason a position angle φi mentioned here is generally assigned to an angular range. Position angle φi may generally correspond to the middle of the above-mentioned angular range, and individual functions 1 through N represent a particular angular range on a shared position angle φi. According to equation 1, quality Q_{φi} for one of position angles φi results from the sum of the product of probability p_{φi,n} ascertained by the particular function for one of position angles φi and weighting factor facₙ for the particular function n across all functions 1 through N, divided by the sum of all weighting factors facₙ of all functions 1 through N.

$$\begin{matrix}{Q}_{ϕ i} = \frac{{\sum }_{n = 1}^{N} {fac}_{n} \cdot {P}_{ϕ i , n}}{{\sum }_{n = 1}^{N} {fac}_{n}} & ( 1 ) \\ {Q}_{max} = max ( {Q}_{ϕ i} ) & ( 2 )\end{matrix}$$

According to equation 2, a maximal quality Qₘₐₓ is ascertained from qualities Q_{φi} ascertained for the particular position angles φi with the aid of equation 1, quality Q_{φi} which has the largest value being selected from the number of ascertained qualities Q_{φi}. The most probable position angle φ_{final} out of position angles φi is the one which is assigned maximal quality Qₘₐₓ. A quality Q_{φi} is thus ascertained in each case for position angles φi as a function of probabilities p_{φi,n} and weighting factors facₙ, and the most probable position angle φ_{final} is determined from position angles φi as a function of quality Q_{φi}. The most probable position angle φ_{final} out of position angles φi is thus ascertained as a function of probabilities p_{φi,n} linked with weighting factors facₙ.

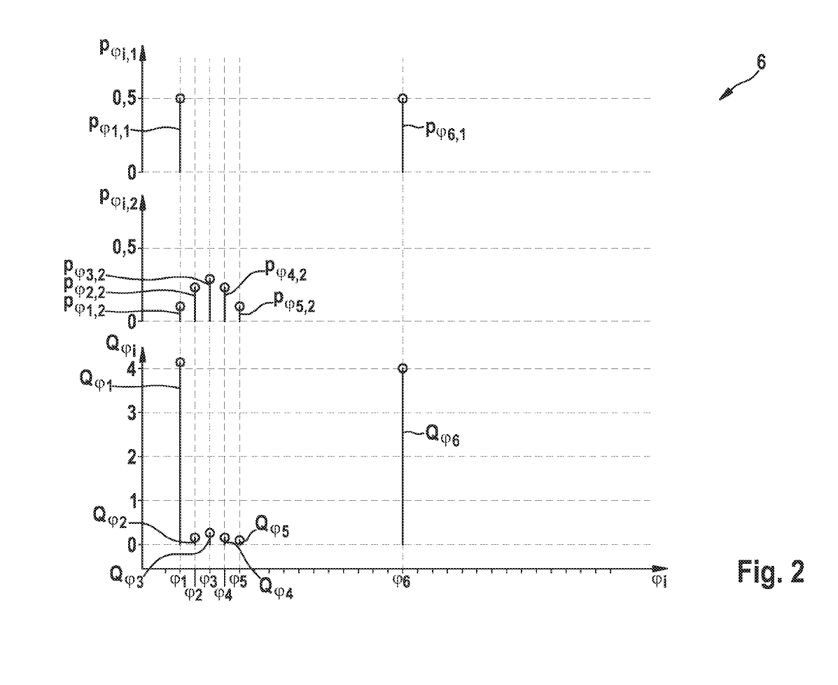

FIG. 2 shows an exemplary diagram 6, in which two probabilities p_{φi,1} and p_{φi,2} and quality Q_{φi} are plotted against position angles φi. Probabilities p_{φi,1} are ascertained by function 1 of FIG. 1. In the present case, the two probabilities p_{φ1,1} and p_{φ6,1} have the same value of 0.5.

Remaining probabilities p_{φi,1} for remaining position angles φi correspond to a value of 0, except for φ1 and φ6. If one of probabilities p_{φi,n} has a value of 0, of course an assignment of the particular probability p_{φi,n} to a position angle φi must be assumed. The sum of all probabilities p_{φi,1} across all position angles φi of a function n results in a value of 1. Of course any other type of representation of the probabilities is possible, for example from 0% to 100%; 0%, which in the example shown corresponds to the number zero, signifying that the event or position angle φi does not occur, and 100%, which in the example shown corresponds to the number one, signifying that the corresponding position angle φi is guaranteed to occur. In this case, function 1 corresponds to a function which ascertains probabilities p_{φi,1} with the aid of an encoder gear wheel on the crankshaft and a corresponding sensor. Since both probabilities p_{φ1,1} and p_{φ6,1} have the same value of 0.5, it is not possible to decide based on the result of function 1 which of the two angles φ1 and φ6 corresponds to the most probable position angle φ_{final}.

Probabilities p_{φi,2}, i.e., probabilities p_{φ1,2} through p_{φ5,2} for position angles φ1 through φ5 are recognized with the aid of function 2 of FIG. 1 based on the rotational speed course when the engine is shut off. For this purpose, for example a position angle φi known during the last injection and the rotational speed course over time until the engine stops are evaluated, and from this a probability distribution, as it is shown in FIG. 2 for probabilities p_{φi,2}, is inferred. Probabilities p_{φ1,2} and p_{φ5,2} each have a value of 0.1. Probabilities p_{φ2,2} and p_{φ4,2} each have a value of 0.25. Probability p_{φ3,2} has a value of 0.3. Remaining probabilities p_{φi,2} for position angles φi each have a value of 0, except for position angles φ1 through φ5. The sum of all probabilities p_{φi,2} is 1.

Now, quality Q_{φi} is ascertained for each position angle φi. Function 1 or probabilities p_{φi,1} is/are assigned weighting factor fac₁ having a value of 4. Function 2, and thus probabilities p_{φi,2}, is/are assigned weighting factor fac₂ having a value of 1. The particular quality Q_{φ1} through Q_{φ6} results for each of the designated angles φ1 through φ6 according to equation 1. The particular quality Q_{φi} is 0 for remaining position angles φi, i.e., except for angles φ1 through φ6.

Considering only position angle φ1, at least two probabilities P_{φ1,1} and p_{φ1,2} are ascertained by the at least two different functions 1 and 2, or the at least two probabilities p_{φ1,1} and P_{φ1,2} are assigned to angle φ1. The at least two probabilities p_{φ1,1} and p_{φ1,2} are linked with each other, and by ascertaining maximal quality Qₘₐₓ, the most probable position angle φ_{final} out of position angles φi is ascertained as a function of linked probabilities p_{φ1,1} and p_{φ1,2}. The method may of course also be carried out without weighting factors facₙ, i.e., with all weighting factors facₙ having a value of 1.

In FIG. 2, quality Q_{φ1} has a value of 4.1, quality Q_{φ2} has a value of 0.25, quality Q_{φ3} has a value of 0.3, quality Q_{φ4} has a value of 0.25, quality Q_{φ5} has a value of 0.1, and quality Q_{φ6} has a value of 4.0. Maximal quality Qₘₐₓ is quality Q_{φ1}, and the most probable position angle φ_{final} is thus position angle φ1.

The most probable position angle φ_{final} generally corresponds to a rotational position of an internal combustion engine. The rotational position of the internal combustion engine refers to a position angle or rotational angle of a shaft, for example the crankshaft or the camshaft of the internal combustion engine. The control of actuators, for example of injectors, or the feedback from sensors may be used to ascertain a position, and thus a position angle φi of the internal combustion engine.

The most probable position angle φfinal shall be understood to mean a position angle φi which according to an assessment by the described method is also present in reality. However, it cannot be excluded that the position angle which is present in reality does not correspond to the most probable position angle φ_{final} as it is ascertained.

The exemplary embodiment according to FIG. 2 refers to the ascertainment of the most probable position angle φ_{final} during or after the internal combustion engine is shut down. The described method may, of course, also be applied to other operating states of the internal combustion engine, such as the start, a constant rotational speed course, or increasing or decreasing rotational speed courses. For this purpose, various functions n may be added or removed.

The above-described methods may be carried out as computer programs for a digital computer. The digital computer is suitable for carrying out the above-described methods as computer programs. The internal combustion engine is provided in particular for a motor vehicle and includes a control unit, which includes the digital computer, in particular a microprocessor. The control unit includes a memory medium on which the computer program is stored.

1-8. (canceled)

9. A method for operating an internal combustion engine, comprising:
ascertaining a most probable position angle which corresponds to a rotational position of the internal combustion engine, at least two probabilities being assigned to each ascertained position angle, the at least two probabilities being linked with each other, and the most probable position angle out of the position angles being ascertained as a function of the linked probabilities.

10. The method as recited in claim 9, wherein the at least two probabilities of at least two different functions are ascertained, the functions being assigned different weighting factors, the at least two probabilities being linked with the assigned weighting factors, and the most probable position angle out of the position angles being ascertained as a function of the probabilities linked with the weighting factors.

11. The method as recited in claim 10, wherein a quality is ascertained in each case for the position angles as a function of the probabilities and the weighting factors, the most probable position angle out of the position angles being determined as a function of the quality.

12. The method as recited in claim 11, wherein the quality for one of the position angles results from the sum of the product of the probability ascertained by the function for one of the position angles and the weighting factor for the function across all functions, divided by a sum of all weighting factors of all functions.

13. The method as recited in claim 11, wherein a maximum quality out of the ascertained qualities is ascertained, the most probable position angle being the position angle to which the maximal quality is assigned.

14. A computer-readable storage medium storing a computer program for a digital computer for operating an internal combustion engine, the computer program, when executed by the digital computer, causing the digital computer to perform:
ascertaining a most probable position angle which corresponds to a rotational position of the internal combustion engine, at least two probabilities being assigned to each ascertained position angle, the at least two probabilities being linked with each other, and the most probable position angle out of the position angles is ascertained as a function of the linked probabilities.

15. A control unit for operating an internal combustion engine in a motor vehicle, the control unit configured to ascertain a most probable position angle which corresponds to a rotational position of the internal combustion engine, at least two probabilities being assigned to each ascertained position angle, the at least two probabilities being linked with each other, and the most probable position angle out of the position angles is ascertained as a function of the linked probabilities.

16. A memory medium for a control unit of an internal combustion engine of a motor vehicle, the memory medium storing a computer program for a digital computer for operating an internal combustion engine, the computer program, when executed by the digital computer, causing the digital computer to perform:
ascertaining a most probable position angle which corresponds to a rotational position of the internal combustion engine, at least two probabilities being assigned to each ascertained position angle, the at least two probabilities being linked with each other, and the most probable position angle out of the position angles is ascertained as a function of the linked probabilities.
